(19) United States
(12) Patent Application Publication
(10) Pub. No.: US 2009/0134191 A1
(43) Pub. Date: May 28, 2009

(54) POWER TOOL WITH HOOK

(76) Inventor: Michael Phillips, Milwaukee, WI (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/324,124

(22) Filed: Nov. 26, 2008

Related U.S. Application Data
(60) Provisional application No. 60/990,837, filed on Nov. 28, 2007.

(51) Int. Cl. A45F 5/00; F21L 4/00

(52) U.S. Cl. 224/269; 362/183

(57) ABSTRACT

A power tool including a housing having a recess formed in a portion of the housing and shaped to receive a hook. The hook being coupled proximate the recess and positionable in a first position substantially in the recess and a second position substantially removed from the recess.

### CROSS-REFERENCE TO RELATED APPLICATIONS

This application claims priority to U.S. Provisional Patent Application No. 60/990,837, entitled “Power Tool with Hook,” filed Nov. 28, 2007 by Michael Phillips and Jonathon A. Zick, the entire contents of which is hereby incorporated by reference.

### BACKGROUND OF THE INVENTION

The present invention relates to an accessory for a power tool, and, more particularly, to a hook element for a power tool.

Workspace is a commodity at many work sites, as well as in the homes of people conducting repairs; therefore, it becomes an inefficient use of the workspace to store or place power tools. Moreover, placing those same power tools on the floor can be hazardous to a user's safety, in addition to causing possible damage to the power tools. Moreover, construction and home improvement projects often occur in dark, difficult to access areas of the work site and/or house. Workers are often required to use both hands to complete a task, and are frequently unable to position a light source or store a tool properly at the work area or place of interest. Using an additional worker to direct the light or hold a tool can be a wasteful use of manpower or even impossible in certain locations and with homeowners trying to complete home repairs.

### SUMMARY

In one embodiment, the invention provides a power tool including a housing having a recess formed in a portion of the housing. The hook being coupled proximate the recess and positionable in a first position substantially in the recess and a second position substantially removed from the recess.

In another embodiment, the invention provides a power tool including a housing having a recess formed in an exterior portion of the housing. A pivot boss is positioned proximate a first end of the recess. A hook is pivotally coupled to the housing at the pivot boss and positionable in a first position substantially within the recess and a second position substantially removed from the recess. A pivot member couples the hook to the housing.

In yet another embodiment, the invention provides a work light including a housing having a recess formed in a portion of the housing and a hook coupled to the housing proximate the recess. The hook is movable between a first position, in which the hook is positioned substantially within the recess, and a second position, in which the hook is positioned at least partially outside of the recess. A pivoting member pivotally couples the hook to the housing. The work light also includes a removable, rechargeable battery pack.

One or more independent features and independent advantages are set forth in the following detailed description.

### BRIEF DESCRIPTION OF THE DRAWINGS

FIG. 1 is rear perspective view of a hook accessory, according to one embodiment of the invention, in an extended position.

FIG. 2 is a perspective view of the hook accessory of FIG. 1 in a collapsed position.

FIG. 3 is an exploded view of the hook accessory of FIG. 1.

FIG. 4 is a side view of the hook accessory of FIG. 1 in the extended position.

FIG. 5 is a rear view of the hook accessory of FIG. 1 in the extended position.

FIG. 6 is a side view of a hook of the hook accessory shown in FIG. 1.

FIG. 7 is a section view of the handle of the hook accessory of FIG. 1 sectioned about line 7-7.

FIG. 8 is a rear perspective view of a hook accessory, according to another embodiment of the invention, in a collapsed position.

Before at least one embodiment of the invention is explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

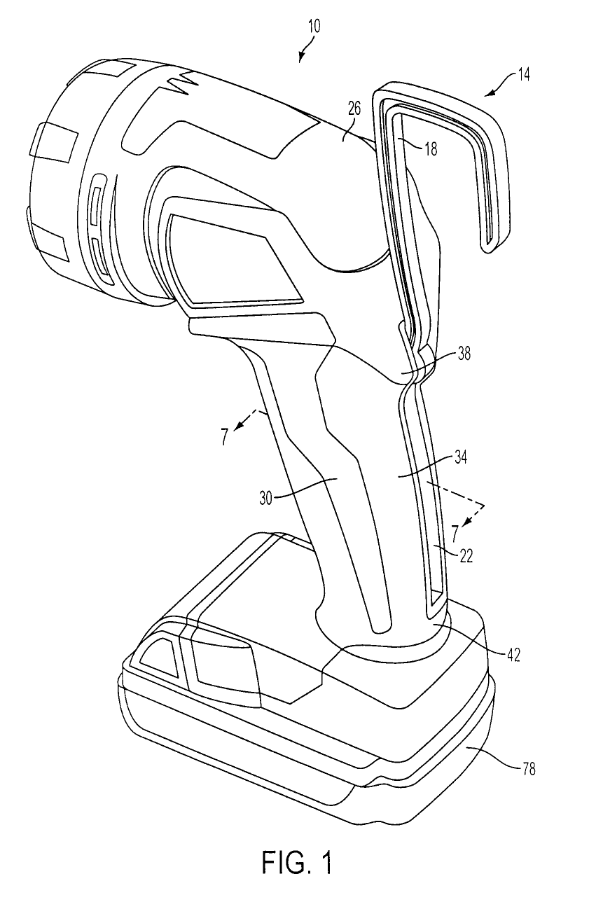

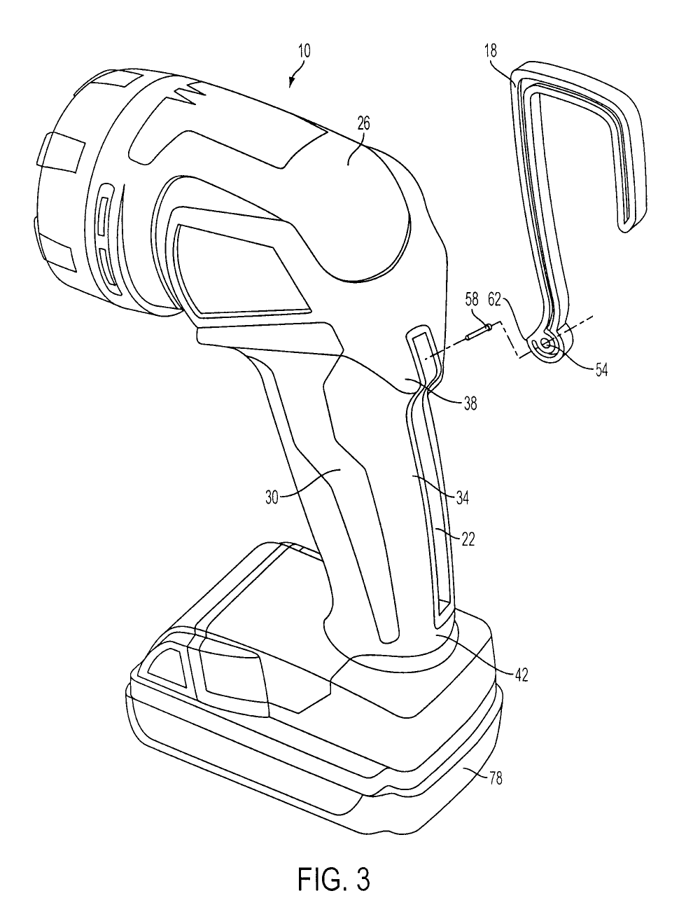

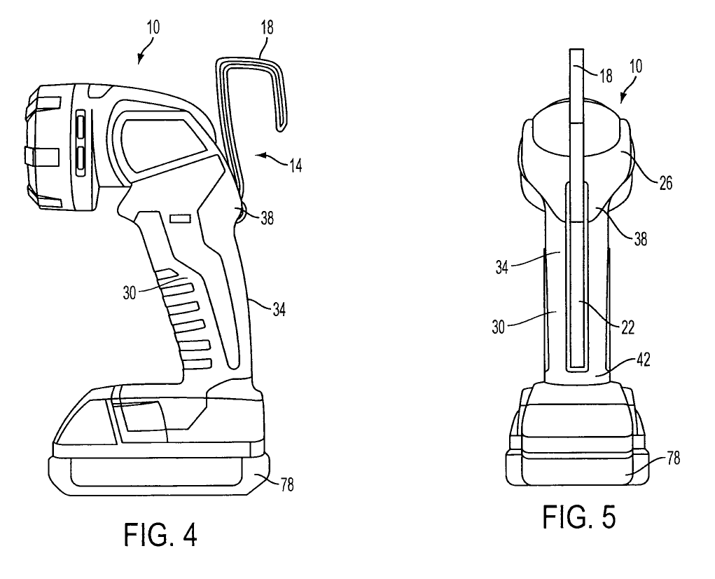

FIGS. 1-7 illustrate a power tool 10 having a hook accessory 14. The power tool 10 is shown as a flashlight; however, in other embodiments, the power tool 10 may be, but is not limited to, another type of power tool, such as a reciprocating saw, a band saw, or the like, or a battery for a power tool. The hook accessory 14 includes a hook 18 configured to support the hanging weight of the power tool 10. The hook 18 is adapted to at least partially enter a recess 22 formed within a housing 26 of the power tool 10. In the illustrated construction, the recess 22 is formed in a handle portion 30 of the power tool 10 along a rear surface 34. The recess 22 may also include a pair of finger slots or other indents (not shown) to allow access to the hook 18 when the hook 18 is stored in the recess 22.

In the illustrated construction, the hook 18 is positioned at an upper end 38 of the recess 22. In other constructions, the hook 18 may be positioned at any location on the power tool 10 where the hook 18 may perform a hook and hang function or a storage function without interfering with the operation of the power tool 10. For example, referring to FIG. 8, the hook 18 is coupled to the housing 26 at a lower end 42 of the recess 22. The hook 18 is formed from a rigid material able to support the hanging weight of the power tool 10 (e.g., plastic or metal).

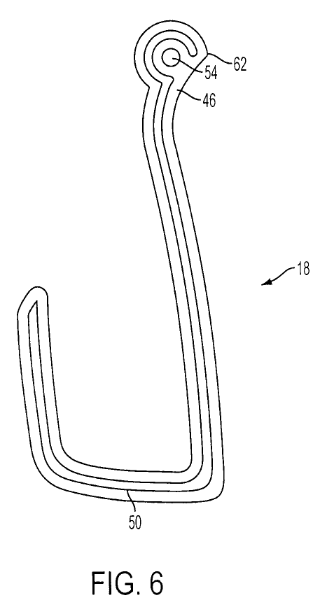

Referring to FIG. 6, the hook 18 includes a pivot end 46 and a hanging end 50. In the illustrated construction, the hanging end 50 is substantially J-shaped; however, in further constructions, the hook 18 may be any shape configured to provide the hook and hang function. The pivot end 46 of the hook 18 includes an aperture 54 shaped to receive and rotate about a pivot pin 58 defining a pivot point. The pivot end 46 also includes a tail 62, or rounded end, for facilitating pivoting action of the hook 18. In other constructions, the pivot pin 58 may be any element that allows the hook 18 to rotate, or the pivot end 46 may be spherical to allow the hook 18 to rotate relative to the housing 26 about an infinite number of axes.

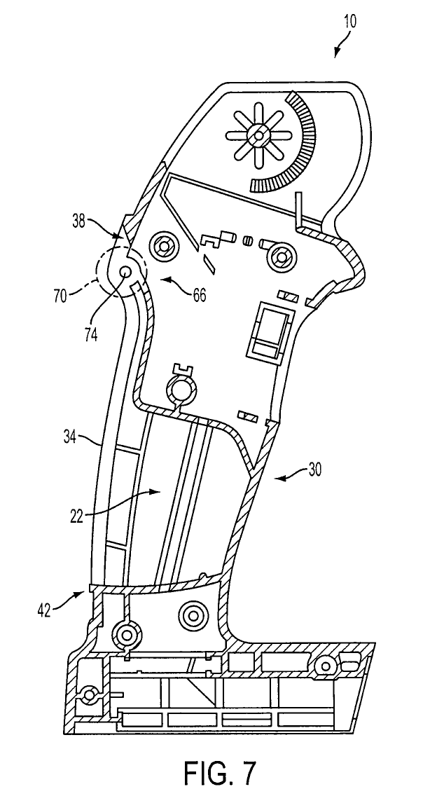

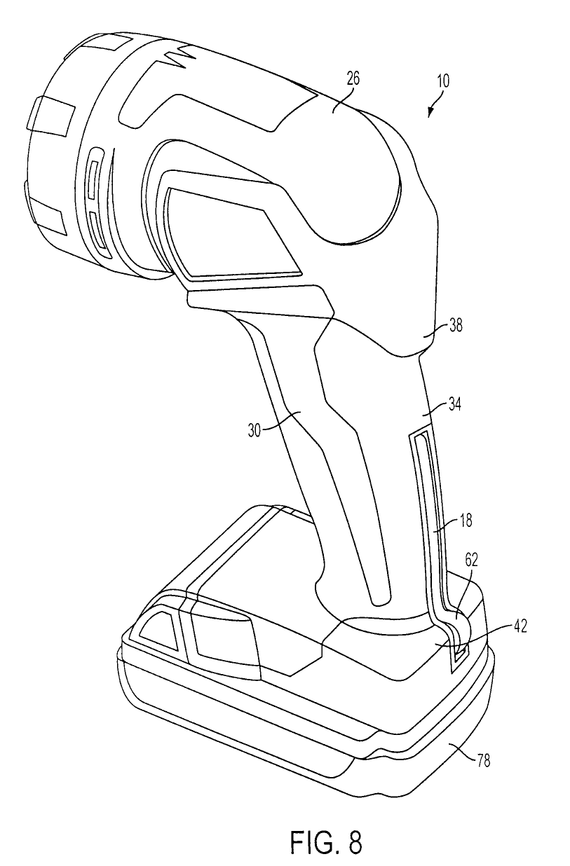

Referring to FIG. 7, an interior portion 66 of the housing 26 includes bosses 70 formed therein for receiving the pivot pin 58 such that the hook 18 is pivotally coupled to the housing 26. Although only one boss 70 is shown in FIG. 7, another boss (not shown) is located opposite the first boss at the other side of the recess 22. Each of the pivot bosses 70 includes an aperture 74 for receiving the pivot pin 58. In another construction, the pivot bosses 70 may be located in an exterior portion (not pictured) of the housing 26, whereby the pivot bosses 70 provide sufficient material about the aperture 74 to properly support the hanging weight of the power tool 10.

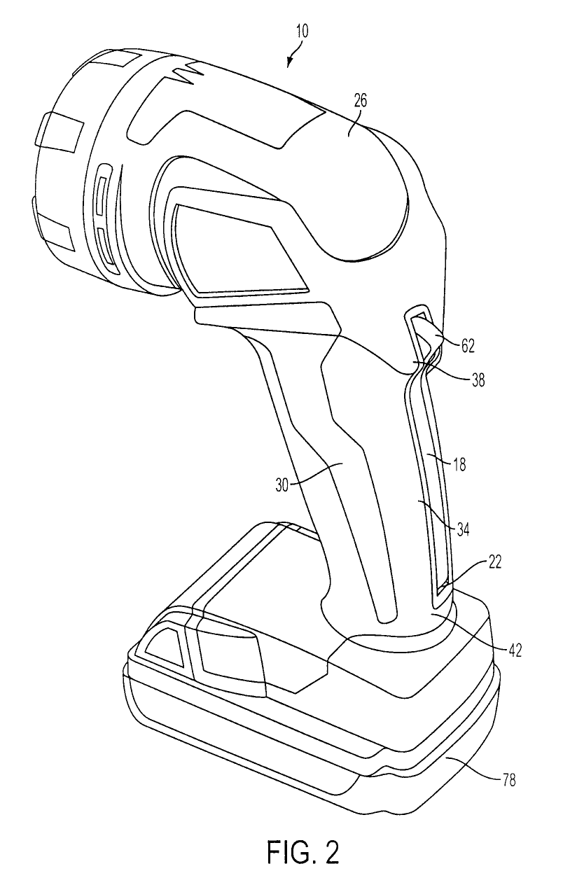

When coupled to the housing 26 of the power tool 10, the hook 18 is pivotable between an extended position (FIG. 1) and a collapsed or recessed position (FIG. 2) through user manipulation. When the hook 18 is in the collapsed position, a user presses on the tail 62 of the hook 18 to pivot the hook 18 out of the recess 18 and into the extended position. In another construction, a user may press or pull on another portion of the hook 18 to pivot the hook 18 out of the recess 22 of the power tool 10.

In the illustrated construction, the hook 18 pivots freely about the pivot pin 58 between the extended position and the collapsed position. In other constructions, the hook 18 may be used in combination with a spring, detent, or other biasing mechanism (not shown) able to assist or maintain the hook 18 in a given position. Additionally, the hook 18 may be retained in the recess 22 by a lock, snap-fit, or other retention mechanism.

A friction fit exists between the hook 18 and the housing 26 such that the hook 18 is movable into a plurality of positions. Referring to FIGS. 2, in the collapsed position, the hook 18 is positioned within the recess 22 of the power tool 10. As shown in FIG. 1, when the hook 18 is in a fully extended position, the hook 18 is rotated approximately 180-degrees from the collapsed position. The hook 18 is also locatable in a number of intermediate positions between the collapsed position and the extended position. In other embodiments, the hook 18 may be rotatable in a range greater than or less than 180 degrees.

In the illustrated construction, the power tool 10 is battery-powered, and includes a rechargeable, removable battery pack 78 electrically coupled to the tool 10 such that the tool is a hand-held, battery-operated power tool. In the illustrated construction, the battery pack 78 is an 18-volt power tool battery pack 78 connected to the handle portion 30 of the housing 26. The battery pack 78 includes five (5) Lithium-ion battery cells and is coupled to the handle portion 30 by sliding. In other embodiments, the battery pack 78 may include fewer or more battery cells such that the battery pack 78 has a lower nominal voltage (e.g., 12-volt, 14.4 volt, etc.) or a higher nominal voltage (e.g., 24-volt, 26 volt, 28-volt, 40-volt, etc.). Additionally or alternatively, the battery cells may have chemistries other than Lithium-ion such as, for example, Nickel Cadmium, Nickel Metal-Hydride, or the like.

The battery pack 78 or other power supply connects to the handle portion 30 of the housing 26 and selectively provides power (e.g., electricity) to the device. In the illustrated construction, the battery pack 78 is slidably coupled to the handle portion 30 of the housing 26 to electrically couple to the device, but may alternatively be coupled to the handle portion 30 by, for example, inserting, snapping, rotating, or the like.

Although the invention has been described in detail with reference to certain preferred embodiments, variations and modifications exist within the scope and spirit of one or more independent aspects of the invention as described.

1. A power tool comprising:
a housing including a recess formed in a portion of the housing; and
a hook coupled to the housing proximate the recess, wherein the hook is movable between a first position in which the hook is positioned substantially within the recess and a second position in which the hook is positioned at least partially outside of the recess.

2. The power tool of claim 1, wherein the housing further includes a pair of pivot bosses proximate the recess.

3. The power tool of claim 2, wherein the hook is pivotably coupled to the housing at the pivot bosses.

4. The power tool of claim 1, wherein the hook is pivotably coupled to the housing by a pivoting member.

5. The power tool of claim 4, wherein the pivoting member is a pin.

6. The power tool of claim 1, wherein the hook is generally J-shaped.

7. The power tool of claim 1, wherein the hook further includes a thumb plate.

8. The power tool of claim 1, wherein a pivot end of the hook is positioned at a first end of the recess.

9. The power tool of claim 1, wherein a pivot end of the hook is positioned at a second end of the recess.

10. The power tool of claim 1, wherein the power tool is a work light.

11. The power tool of claim 1, further comprising a removable, rechargeable battery pack.

12. A power tool comprising:
a housing including a recess formed in an exterior portion of the housing;
a pivot boss positioned proximate a first end of the recess;
a hook pivotally coupled to the housing at the pivot boss, wherein the hook is movable between a first position in which the hook is positioned substantially within the recess and a second position in which the hook is positioned at least partially outside of the recess; and
a pivot member for coupling the hook to the housing.

13. The power tool of claim 12, wherein the pivot member is a pin.

14. The power tool of claim 12, wherein the hook further includes a thumb plate.

15. The power tool of claim 12, wherein the power tool is a work light.

16. The power tool of claim 12, wherein the hook is generally J-shaped.

17. The power tool of claim 12, further comprising a removable, rechargeable battery pack.

18. The power tool of claim 12, wherein the pivot boss comprises a pair of pivot bosses formed in the housing for pivotally coupling the hook to the housing with the pivot member.

19. A work light comprising:
a housing including a recess formed in a portion of the housing;
a hook coupled to the housing proximate the recess, wherein the hook is movable between a first position in which the hook is positioned substantially within the recess and a second position in which the hook is positioned at least partially outside of the recess;
a pivoting member pivotally coupling the hook to the housing; and
a removable, rechargeable battery pack.
